(19) United States
(12) Patent Application Publication
(10) Pub. No.: US 2025/0012653 A1
(43) Pub. Date: Jan. 9, 2025

(54) PRESSURE DETECTION ELEMENT, LIQUID DISCHARGE HEAD, AND LIQUID DISCHARGE DEVICE

(71) Applicant: SEIKO EPSON CORPORATION, Tokyo (JP)

(72) Inventors: Motoki TAKABE, SHIOJIRI-SHI (JP); Yu SHIOZAWA, SHIOJIRI-SHI (JP); Shingo TOMIMATSU, SHIOJIRI-SHI (JP)

(21) Appl. No.: 18/764,550

(22) Filed: Jul. 5, 2024

(30) Foreign Application Priority Data
Jul. 7, 2023 (JP) 2023-112254

(51) Int. Cl. G01L 9/12; B41J 2/14

(52) U.S. Cl. CPC G01L 9/12; B41J 2/14201; B41J 2002/14354

(57) ABSTRACT

A pressure detection element includes a pressure detection chamber for detecting pressure inside, a first electrode, a second electrode, and a first piezoelectric body that is disposed between the first and second electrodes and capacitance of which changes in accordance with the pressure of the pressure detection chamber. The first piezoelectric body includes a first piezoelectric layer positioned on the first electrode side and a second piezoelectric layer positioned on the second electrode side. The second piezoelectric layer is in the tetragonal, cubic, or monoclinic crystal system. The first piezoelectric layer is in the rhombohedral crystal system. Thickness of the second piezoelectric layer is smaller than thickness of the first piezoelectric layer.

The present application is based on, and claims priority from JP Application Serial Number 2023-112254, filed Jul. 7, 2023, the disclosure of which is hereby incorporated by reference herein in its entirety.

### BACKGROUND

### 1. Technical Field

The present disclosure relates to a pressure detection element, a liquid discharge head, and a liquid discharge device.

### 2. Related Art

Sensors used for measurement of a physical quantity such as pressure or acceleration are known. JP-A-2002-55116 discloses a ceramic sensor in which a piezoelectric ceramic single crystal thin film is formed on a metal foil, an electrode is attached thereon, and an electric circuit is formed through a detection means between the metal foil and the electrode. The electric circuit is formed between the electrode and the metal foil. In such a ceramic sensor, current or voltage change occurs when mechanical impulsion is applied to the piezoelectric ceramic. The electric circuit functions as a sensor when provided with an ammeter or a voltmeter.

However, the piezoelectric ceramic disclosed in JP-A-2002-55116 is a single layer. Deformation of the piezoelectric ceramic is small even when large stress is applied. Accordingly, permittivity change is small, which makes it difficult to achieve high detection sensitivity. Thus, it is difficult to obtain high detection sensitivity with piezoelectric ceramic of a single layer as disclosed in JP-A-2002-55116.

### SUMMARY

A pressure detection element according to a preferable aspect of the present disclosure includes a pressure detection chamber for detecting pressure inside, a first electrode, a second electrode, and a first piezoelectric body that is disposed between the first and second electrodes and capacitance of which changes in accordance with the pressure of the pressure detection chamber. The first piezoelectric body includes a first piezoelectric layer positioned on the first electrode side and a second piezoelectric layer positioned on the second electrode side. The second piezoelectric layer is in the tetragonal, cubic, or monoclinic crystal system. The first piezoelectric layer is in the rhombohedral crystal system. Thickness of the second piezoelectric layer is smaller than thickness of the first piezoelectric layer.

A pressure detection element according to a preferable aspect of the present disclosure includes a pressure detection chamber for detecting pressure inside, a first electrode, a second electrode, and a first piezoelectric body that is disposed between the first and second electrodes and capacitance of which changes in accordance with the pressure of the pressure detection chamber. The first piezoelectric body includes a first piezoelectric layer positioned on the first electrode side and a second piezoelectric layer positioned on the second electrode side. Young's modulus of the second piezoelectric layer is smaller than Young's modulus of the first piezoelectric layer. Thickness of the second piezoelectric layer is smaller than thickness of the first piezoelectric layer.

A liquid discharge head according to a preferable aspect of the present disclosure includes the pressure detection element, a nozzle substrate provided with a nozzle that discharges liquid, a pressure chamber substrate including a pressure chamber in which pressure for discharging liquid from the nozzle is applied to liquid and the pressure detection chamber adjacent to the pressure chamber, and a second piezoelectric body that is provided corresponding to the pressure chamber and applies pressure to the pressure chamber upon voltage application. The pressure detection element is provided corresponding to the pressure detection chamber.

A liquid discharge device according to a preferable aspect of the present disclosure includes the liquid discharge head and a control section configured to control discharge operation from the liquid discharge head.

### BRIEF DESCRIPTION OF THE DRAWINGS

FIG. 1 is a schematic diagram exemplarily illustrating the configuration of a liquid discharge device according to a first embodiment.

FIG. 2 is a block diagram of the liquid discharge device in FIG. 1.

FIG. 3 is a cross-sectional view of part of a liquid discharge head illustrated in FIG. 1.

FIG. 4 is a diagram illustrating part of a pressure chamber substrate in FIG. 3.

FIG. 5 is a diagram illustrating part of a sealing substrate in FIG. 3.

FIG. 6 is a cross-sectional view of a pressure detection element in FIG. 3.

FIG. 7 is a graph illustrating an example of the relation between the capacitance of a first piezoelectric body and pressure.

FIG. 8 is a diagram illustrating a pressure detection element and a third piezoelectric element in FIG. 2.

FIG. 9 is a cross-sectional view of a pressure detection element according to a modification.

FIG. 10 is a plan view illustrating the pressure detection element according to a modification.

FIG. 11 is a plan view illustrating the pressure detection element according to a modification.

FIG. 12 is a cross-sectional view of a second piezoelectric element and a pressure detection element according to a modification.

FIG. 13 is a cross-sectional view of a second piezoelectric element and a pressure detection element according to a modification.

FIG. 14 is a block diagram of a liquid discharge device according to a modification.

FIG. 15 is a diagram illustrating an example of the relation between voltage and electric charge.

FIG. 16 is a diagram illustrating an example of the relation between voltage and capacitance.

### DESCRIPTION OF EMBODIMENTS

Preferable embodiments of the present disclosure will be described below with reference to the accompanying drawings. The dimension or scale of each component in the drawings is different from that in reality as appropriate and sometimes schematically illustrated to facilitate understanding. The scope of the present disclosure is not limited to the embodiments unless explicitly described otherwise to limit the present disclosure in the following description. Moreover, meaning of “element β on element α” is not limited to a configuration in which element α and element β directly contact each other, but includes a configuration in which element α and element β do not directly contact each other. In addition, meaning of “element α and element β are substantially equal to each other” includes a case where the elements are precisely equal to each other as well as a case where the elements have difference equivalent to manufacturing error and measurement error.

### 1. First Embodiment

### 1-1. Entire Configuration of Liquid Discharge Device 100

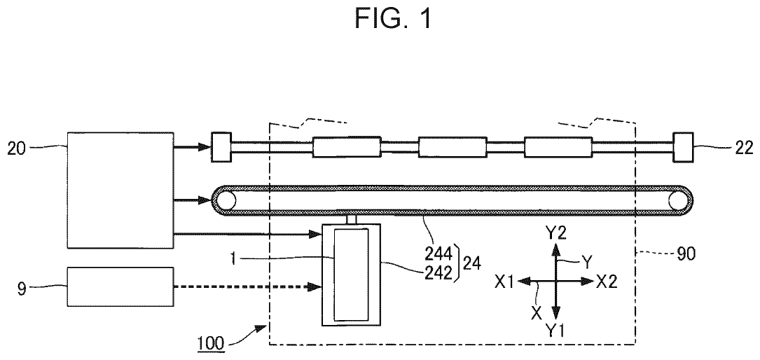

FIG. 1 is a schematic diagram exemplarily illustrating the configuration of a liquid discharge device 100 according to a first embodiment. In the following description, an X axis, a Y axis, and a Z axis orthogonal to one another are used as appropriate for the purpose of illustration. One direction along the X axis is referred to as an X1 direction, and the other direction opposite the X1 direction is referred to as an X2 direction. Similarly, one direction along the Y axis is referred to as a Y1 direction, and the other direction opposite the Y1 direction is referred to as a Y2 direction. One direction along the Z axis is referred to as a Z1 direction, and the other direction opposite the Z1 direction is referred to as a Z2 direction.

The liquid discharge device 100 in FIG. 1 is an ink jet printing device that discharges ink as exemplary liquid onto a medium 90. The medium 90 is typically a printing sheet, but a printing target of an optional material, such as a resin film or cloth is used as the medium 90. As exemplarily illustrated in FIG. 1, a liquid container 9 in which ink is accumulated is installed in the liquid discharge device 100. For example, a cartridge detachably attached to the liquid discharge device 100, an ink pack formed in a bag shape of a flexible film, or an ink tank that can be replenished with ink is used as the liquid container 9.

The liquid discharge device 100 includes a control unit 20, a medium transport mechanism 22, a movement mechanism 24, and a liquid discharge head 1. The control unit 20 includes one or a plurality of processing circuits such as a central processing unit (CPU) and a field programmable gate array (FPGA), and one or a plurality of storage circuits such as semiconductor memories, and collectively controls elements of the liquid discharge device 100.

The medium transport mechanism 22 transports the medium 90 in a direction along the Y axis under control by the control unit 20. The movement mechanism 24 reciprocates the liquid discharge head 1 along the X axis under control by the control unit 20. The movement mechanism 24 includes a substantially box-shaped transport body 242 in which the liquid discharge head 1 is housed, and a transport belt 244 to which the transport body 242 is fixed. Alternatively, a configuration in which a plurality of liquid discharge heads 1 are mounted on the transport body 242 or a configuration in which the liquid container 9 is mounted on the transport body 242 together with the liquid discharge head 1 may be employed.

The liquid discharge head 1 discharges ink supplied from the liquid container 9 onto the medium 90 through a plurality of nozzles under control by the control unit 20. An image is formed on a surface of the medium 90 as the liquid discharge head 1 discharges ink onto the medium 90 in parallel to transport of the medium 90 by the medium transport mechanism 22 and repetitive reciprocation of the transport body 242.

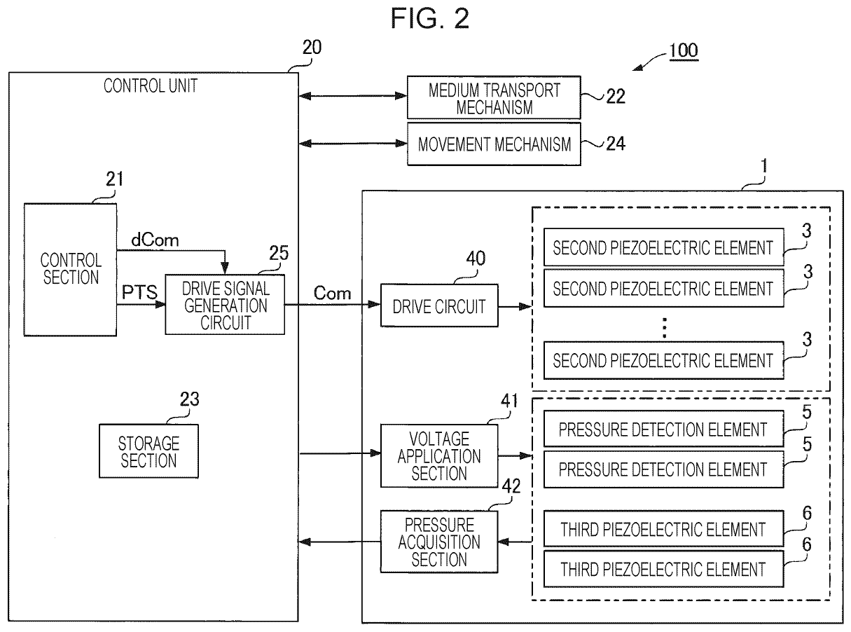

FIG. 2 is a block diagram of the liquid discharge device 100 in FIG. 1. As illustrated in FIG. 2, the liquid discharge device 100 includes the control unit 20, the medium transport mechanism 22, the movement mechanism 24, and the liquid discharge head 1. The control unit 20 includes a control section 21, a storage section 23, and a drive signal generation circuit 25. The liquid discharge head 1 includes a drive circuit 40, a plurality of second piezoelectric elements 3, a voltage application section 41, a pressure acquisition section 42, at least one pressure detection element 5, and at least one third piezoelectric element 6.

The control section 21 includes one or a plurality of processing circuits such as a CPU or a FPGA. The control section 21 generates a signal for controlling operation of each component of the liquid discharge device 100. The control section 21 controls ink discharge operation by the liquid discharge head 1.

The control section 21 generates a printing signal SI, a waveform designation signal dCom, and a timing signal PTS. The printing signal SI is a digital signal for designating the kind of operation of the liquid discharge head 1. The printing signal SI designates whether to supply a drive signal Com to the second piezoelectric elements 3. The waveform designation signal dCom is a digital signal that defines the waveform of the drive signal Com. The drive signal Com is an analog signal for driving the second piezoelectric elements 3. The timing signal PTS is a signal that defines the generation timing of the drive signal Com.

The storage section 23 includes one or a plurality of storage circuits such as semiconductor memories. The storage section 23 stores printing data Img supplied from a host computer. The storage section 23 stores a control program of the liquid discharge device 100.

The drive signal generation circuit 25 includes a DA conversion circuit. The drive signal generation circuit 25 generates the drive signal Com having a waveform defined by the waveform designation signal dCom. The drive signal generation circuit 25 outputs the drive signal Com each time the timing signal PTS is received.

The drive circuit 40 switches whether to supply the drive signal Com to each second piezoelectric element 3 based on the printing signal SI. The drive circuit 40 selects a second piezoelectric element 3 to which the drive signal Com is to be supplied based on the printing signal SI, a latch signal LAT, and a change signal CH supplied from the control unit 20. The latch signal LAT defines the latch timing of the printing data Img. The change signal CH defines the selection timing of a drive pulse included in the drive signal Com.

The voltage application section 41 applies predetermined voltage to the at least one pressure detection element 5 and the at least one third piezoelectric element 6. The voltage application section 41 includes, for example, a power circuit. The pressure acquisition section 42 acquires pressure in a pressure detection chamber S2 included in the liquid discharge head 1, which will be described later, based on voltage applied to the pressure detection element 5. The pressure acquisition section 42 outputs, for example, a detection signal as a voltage value.

The liquid discharge device 100 includes the liquid discharge head 1, and the control unit 20 including the control section 21 configured to control discharge operation from the liquid discharge head 1. The liquid discharge head 1 includes the pressure detection element 5 that can exert more excellent detection sensitivity than the related art which will be described later. Thus, according to the present embodiment, it is possible to provide the liquid discharge device 100 including the liquid discharge head 1 capable of sensing pressure in the pressure detection chamber S2 at high sensitivity.

### 1-2. Liquid Discharge Head 1

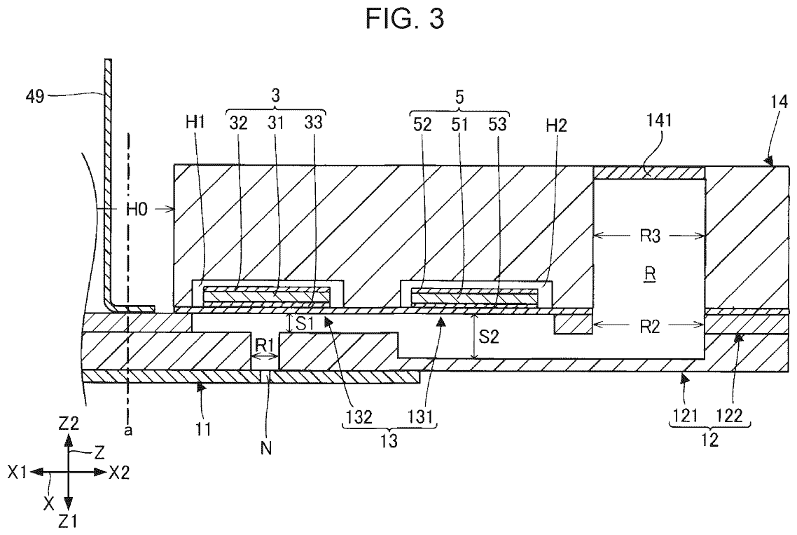

FIG. 3 is a cross-sectional view of part of the liquid discharge head 1 illustrated in FIG. 1, illustrating a section parallel to an X-Z plane. The Z axis is an axis line extending in the direction of ink discharge by the liquid discharge head 1. A view in a direction along the Z axis is referred to as a “plan view”.

The liquid discharge head 1 in FIG. 3 has a structure that is substantially plane symmetric with respect to a virtual surface “a” along a Y-Z plane. The following description will be mainly made on a configuration on the right side in FIG. 3 relative to the virtual surface “a”, and description of a configuration on the left side in FIG. 3 relative to the virtual surface “a” will be omitted as appropriate.

The liquid discharge head 1 includes a nozzle substrate 11, a pressure chamber substrate 12, a vibration plate 13, a sealing substrate 14, a wiring substrate 49, the second piezoelectric elements 3, and the pressure detection element 5. Each second piezoelectric element 3 includes a second piezoelectric body 31, a third electrode 32, and a fourth electrode 33. The pressure detection element 5 includes a first piezoelectric body 51, a first electrode 52, and a second electrode 53. Although not illustrated in details, the nozzle substrate 11, the pressure chamber substrate 12, the vibration plate 13, and the sealing substrate 14 have plate shapes elongated along the Y axis.

The nozzle substrate 11 is a plate member provided with a plurality of nozzles N that discharge ink as an example of liquid. Each of the plurality of nozzles N is a circular through-hole that discharges ink. The plurality of nozzles N are arrayed straight along the Y axis. The nozzle substrate 11 is manufactured by fabricating a semiconductor substrate such as a single crystal substrate made of, for example, silicon.

The pressure chamber substrate 12 is a flow path structural body in which a flow path for supplying ink to each of the plurality of nozzles N is formed. The pressure chamber substrate 12 is a stacked body of a first substrate 121 and a second substrate 122. The first substrate 121 and the second substrate 122 are each manufactured by fabricating a semiconductor substrate such as a single crystal substrate made of, for example, silicon. The first substrate 121 and the second substrate 122 may be each integrally formed. The pressure chamber substrate 12 may include a member other than the first substrate 121 and the second substrate 122.

Ink flow paths are formed in the pressure chamber substrate 12. Specifically, a plurality of pressure chambers S1, the pressure detection chamber S2, a plurality of first communication flow paths R1, and a second communication flow path R2 are formed in the pressure chamber substrate 12. The first substrate 121 and the second substrate 122 each have a recessed part or a through-hole, and the plurality of pressure chambers S1, the pressure detection chamber S2, the plurality of first communication flow paths R1, and the second communication flow path R2 are formed by the recessed parts or through-holes.

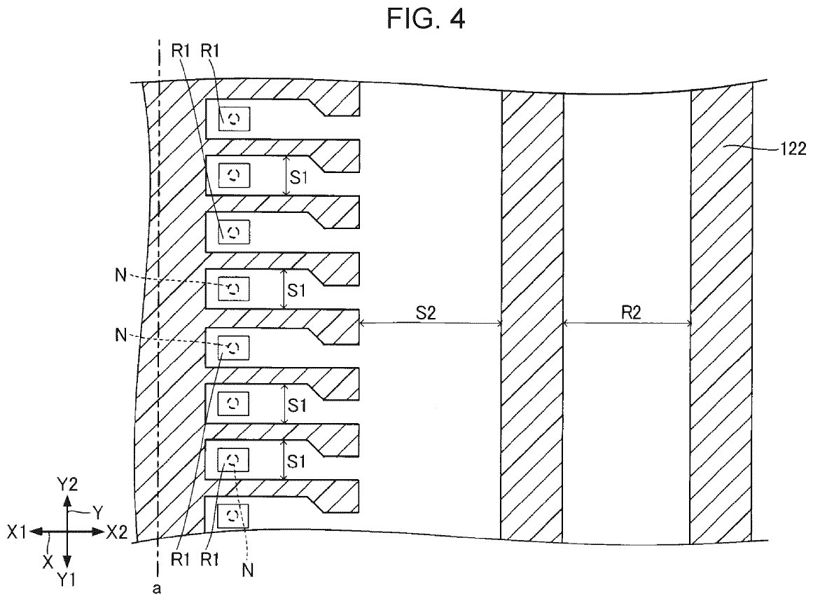

FIG. 4 is a diagram illustrating part of the pressure chamber substrate 12 in FIG. 3. As illustrated in FIG. 4, each pressure chamber S1 has a longitudinal shape extending in the X2 direction. The plurality of pressure chambers S1 are separated from each other and arranged in the Y2 direction. The plurality of pressure chambers SI are provided on a one-to-one basis with the plurality of nozzles N. Each pressure chamber S1 is a space in which pressure for discharging ink from the corresponding nozzle N is applied to ink.

The plurality of first communication flow paths R1 are separated from each other and arranged in the Y2 direction. The plurality of first communication flow paths R1 are provided on a one-to-one basis with the plurality of pressure chambers S1. Each first communication flow path R1 provides communication between the corresponding pressure chamber S1 and the corresponding nozzle N. Each first communication flow path R1 overlaps the corresponding pressure chamber S1 and the corresponding nozzle N in a plan view.

The pressure detection chamber S2 is provided upstream of the plurality of pressure chambers S1. The pressure chambers S1 and the pressure detection chamber S2 are arranged in the X2 direction. The pressure detection chamber S2 has a longitudinal shape extending in the Y2 direction. The volume of the pressure detection chamber S2 is extremely larger than the volume of each pressure chamber S1. The pressure detection chamber S2 is provided in common to the plurality of pressure chambers S1 and connected to the plurality of pressure chambers S1. The pressure detection chamber S2 is adjacent to the pressure chambers S1 and absorbs ink vibration that occurs when pressure is applied to ink in the pressure chambers S1. With the pressure detection chamber S2 provided, ink discharge performance can be stabilized. Moreover, since the pressure detection chamber S2 is adjacent to the pressure chambers S1, the efficiency of ink vibration absorption can be enhanced as compared to a case where the chambers are separated from each other. Accordingly, the stability of ink discharge performance can be increased.

The second communication flow path R2 is provided upstream of the pressure detection chamber S2 and connected to the pressure detection chamber S2. The second communication flow path R2 has a longitudinal shape extending in the Y2 direction.

As illustrated in FIG. 3, the vibration plate 13 is disposed on a surface of the pressure chamber substrate 12 in the Z2 direction. The thickness of the vibration plate 13 is extremely smaller than the thicknesses of the first substrate 121 and the second substrate 122 of the pressure chamber substrate 12. The thicknesses are lengths in the Z1 direction. The vibration plate 13 is elastically deformable. The vibration plate 13 includes a plurality of second vibration plates 132 and a first vibration plate 131. The plurality of second vibration plates 132 and the first vibration plate 131 are formed of one member.

The plurality of second vibration plates 132 are provided on a one-to-one basis with the plurality of pressure chambers S1. The second vibration plates 132 are parts of the vibration plate 13, which overlap the plurality of pressure chambers S1 in a plan view. The second vibration plates 132 form parts of the pressure chambers S1. Each second vibration plate 132 vibrates and applies pressure to the corresponding pressure chamber S1 as voltage is applied to the second piezoelectric body 31 included in the corresponding second piezoelectric element 3. Since the second vibration plates 132 are provided, the second piezoelectric elements 3 can be provided on the pressure chambers S1 and pressure due to vibration that occurs with voltage application to the second piezoelectric bodies 31 through the second vibration plates 132 can be efficiently applied to the pressure chambers S1.

The first vibration plate 131 is a part of the vibration plate 13, which overlaps the pressure detection chamber S2 in a plan view. The first vibration plate 131 forms a part of the pressure detection chamber S2. The first vibration plate 131 is driven with pressure application from the pressure detection chamber S2 and applies pressure to the first piezoelectric body 51 included in the pressure detection element 5. Since the first vibration plate 131 is provided, the pressure detection element 5 can be provided on the pressure detection chamber S2 and pressure can be efficiently applied to the first piezoelectric body 51.

The plurality of second vibration plates 132 and the first vibration plate 131 are not separated from each other but are formed of a continuous member. Thus, each second vibration plate 132 and the first vibration plate 131 can be easily positioned adjacent to each other. Accordingly, the plurality of pressure chambers S1 and the pressure detection chamber S2 can be easily positioned adjacent to each other. Since the plurality of pressure chambers S1 and the pressure detection chamber S2 can be positioned adjacent to each other, the of ink vibration absorption efficiency can be enhanced.

The vibration plate 13 is manufactured by fabricating a semiconductor substrate such as a single crystal substrate made of, for example, silicon. The vibration plate 13 may be formed of a part of the pressure chamber substrate 12. For example, the vibration plate 13 may be formed by reducing the thickness of a part of the second substrate 122. The vibration plate 13 may be configured as a stacked body of a plurality of layers. For example, the vibration plate 13 is formed of a stacked body of a silicon oxide film and a zirconium oxide film, the silicon oxide film being formed by thermally oxidizing a single crystal substrate of silicon.

The sealing substrate 14 is disposed on a surface of the vibration plate 13 in the Z2 direction. The sealing substrate 14 is a structural body that protects the plurality of second piezoelectric elements 3 and the pressure detection element 5 to be described later and reinforces the mechanical strength of the pressure chamber substrate 12.

A third communication flow path R3, a first space H1, a second space H2, and a wiring space H0 are formed in the sealing substrate 14. The sealing substrate 14 has recessed parts or through-holes, and each flow path or space is formed by these recessed parts or through-holes. The third communication flow path R3 and the wiring space H0 are holes penetrating through the sealing substrate 14. The first space H1 and the second space H2 are spaces surrounded by recessed parts formed in the sealing substrate 14.

The third communication flow path R3 overlaps the above-described second communication flow path R2 in a plan view and is connected to the second communication flow path R2. A common ink chamber R is formed by the third communication flow path R3 and the second communication flow path R2. The common ink chamber R functions as a reservoir. A filter 141 for removing air bubbles and foreign objects mixed in ink is provided at a part overlapping the common ink chamber R in a plan view. The filter 141 may be omitted.

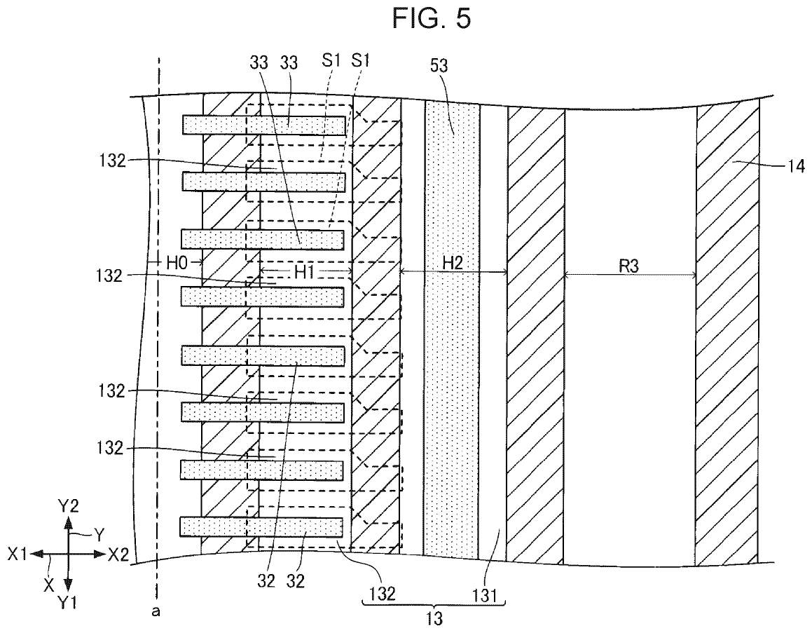

FIG. 5 is a plan view illustrating part of the sealing substrate 14 in FIG. 3. In FIG. 5, for convenience sake, the fourth electrodes 33 of the second piezoelectric elements 3 and the second electrode 53 of the pressure detection element 5 are dotted.

As illustrated in FIG. 5, the first space H1, the second space H2, the third communication flow path R3, and the wiring space H0 each have a longitudinal shape extending in the Y2 direction. The wiring space H0, the first space H1, the second space H2, and the third communication flow path R3 are arranged in the stated order in the X2 direction.

As illustrated in FIG. 3, the plurality of second piezoelectric elements 3 are disposed in the first space H1. The pressure detection element 5 is disposed in the second space H2. The wiring substrate 49 is disposed in the wiring space H0. The wiring substrate 49 is joined to the pressure chamber substrate 12. The wiring substrate 49 is a mounting component in which a plurality of wires for electrically connecting the control unit 20 and the liquid discharge head 1 are formed. For example, a tape carrier package (TCP) or a flexible printed circuit (FPC) is used as the wiring substrate 49.

Each second piezoelectric element 3 has a longitudinal shape extending in the X2 direction. The plurality of second piezoelectric elements 3 are separated from each other and arranged in the Y2 direction. The plurality of second piezoelectric elements 3 are provided on a one-to-one basis with the plurality of pressure chambers S1. The pressure detection element 5 has a longitudinal shape extending in the Y2 direction and extends in a direction intersecting the plurality of second piezoelectric elements 3. The pressure detection element 5 is provided corresponding to the pressure detection chamber S2 and overlaps the pressure detection chamber S2 in a plan view.

The second piezoelectric elements 3 are provided corresponding to the pressure chambers S1. Specifically, the second piezoelectric elements 3 are disposed for the pressure chambers S1, respectively, on surfaces of the second vibration plates 132, which are opposite the pressure chambers S1. Each second piezoelectric element 3 is an energy generation element that generates energy for discharging ink upon application of the drive signal Com. Each second piezoelectric element 3 is also a drive element that drives upon application of the drive signal Com. Upon voltage application, the second piezoelectric elements 3 contract, bend the second vibration plates 132, and pressurize the pressure chambers S1.

Each second piezoelectric element 3 schematically includes the fourth electrode 33, the second piezoelectric body 31, and the third electrode 32. The fourth electrode 33, the second piezoelectric body 31, and the third electrode 32 are stacked in the stated order from the corresponding second vibration plate 132. Accordingly, the third electrode 32 is positioned in the Z2 direction with respect to the second piezoelectric body 31. The fourth electrode 33 is positioned in the Z1 direction with respect to the second piezoelectric body 31. The fourth electrode 33 and the second vibration plate 132 may contact each other, or another member may be interposed between the fourth electrode 33 and the second vibration plate 132.

The second piezoelectric body 31 is a dielectric body individually provided for each of the plurality of second piezoelectric elements 3. The plurality of second piezoelectric bodies 31 may be connected to each other. For example, the plurality of second piezoelectric bodies 31 may be separated from each other by forming a plurality of cutouts in a strip-shaped dielectric film extending in the Y2 direction. Thus, the plurality of second piezoelectric bodies 31 may be formed of one dielectric film. Each second piezoelectric body 31 is formed of a piezoelectric material such as piezoelectric zirconate titanate (Pb(Zr, Ti)O₃).

The third electrode 32 is a common electrode provided in common to the plurality of second piezoelectric bodies 31. The third electrode 32 has a strip shape extending in the Y2 direction continuously across the plurality of second piezoelectric elements 3. The third electrode 32 is provided in common to the plurality of pressure chambers S1. Since the third electrode 32 is provided in common, the second piezoelectric elements 3 can be easily miniaturized as compared to a case where the third electrode 32 is individually provided. Similarly to the fourth electrodes 33, the third electrode 32 is formed of a low-resistance conductive material such as platinum (Pt) or iridium (Ir).

As illustrated in FIG. 5, each fourth electrode 33 has an elongated shape along the X axis. The plurality of fourth electrodes 33 are arrayed along the Y axis. The fourth electrodes 33 are individual electrodes formed in separation from each other for the second piezoelectric elements 3, respectively. The fourth electrodes 33 are individually provided for the plurality of pressure chambers S1. Since the fourth electrodes 33 are individually provided, one dielectric film can be partitioned into the plurality of second piezoelectric bodies 31 when the plurality of second piezoelectric bodies 31 are formed of the one dielectric film. The fourth electrodes 33 are formed of a conductive material such as platinum or iridium.

The second piezoelectric elements 3 are piezoelectric elements related to ink discharge. Reference voltage that is constant voltage is applied to the third electrode 32. The reference voltage may be, for example, ground voltage or voltage higher than ground voltage. The drive signal Com is supplied to the fourth electrodes 33. Accordingly, drive voltage that changes with time is applied to the fourth electrodes 33.

Voltage corresponding to the difference between the reference voltage applied to the third electrode 32 and the drive voltage supplied to the fourth electrodes 33 is applied to the second piezoelectric bodies 31. In other words, the drive circuit 40 in FIG. 2 described above applies drive voltage that changes with time to the second piezoelectric bodies 31. As the second piezoelectric bodies 31 deform when the voltage corresponding to the difference between the reference voltage applied to the third electrode 32 and the drive voltage supplied the fourth electrodes 33 is applied to the second piezoelectric bodies 31, the second piezoelectric elements 3 generates energy that deflects and deforms the second vibration plates 132. In this manner, with the voltage application, the second piezoelectric elements 3 apply pressure to the pressure chambers S1. As the second vibration plates 132 deflect and deform due to the energy generated by the second piezoelectric elements 3, pressure in the pressure chambers S1 changes and ink in the pressure chambers S1 is discharged from the nozzles N illustrated in FIG. 3.

The pressure detection element 5 illustrated in FIG. 3 is provided corresponding to the pressure detection chamber S2. Specifically, the pressure detection element 5 is disposed on a surface of the first vibration plate 131, which is opposite the pressure detection chamber S2. The pressure detection element 5 is used to detect pressure in the pressure detection chamber S2. The pressure detection element 5 deforms in accordance with the first vibration plate 131 deflecting in accordance with pressure in the pressure detection chamber S2.

The pressure detection element 5 includes the second electrode 53, the first piezoelectric body 51, and the first electrode 52. The second electrode 53, the first piezoelectric body 51, and the first electrode 52 are stacked in the stated order from the first vibration plate 131. The second electrode 53 and the first vibration plate 131 may contact each other, or another member may be interposed between the second electrode 53 and the first vibration plate 131.

The first piezoelectric body 51 is a strip-shaped dielectric film extending in the Y2 direction. The first piezoelectric body 51 is formed of a well-known piezoelectric material such as piezoelectric zirconate titanate. The thickness of the first piezoelectric body 51 is equal to the thickness of each second piezoelectric body 31. The thicknesses are lengths in the Z1 direction.

The first electrode 52 and the second electrode 53 each have an elongated shape along the Y axis. The first electrode 52 and the second electrode 53 are each formed of a conductive material such as platinum or iridium. For example, in the second electrode 53, a first layer containing titanium, a second layer containing platinum, a third layer containing iridium, and a fourth layer containing titanium are stacked in order from the first vibration plate 131. The thickness of the first layer is smaller than the thickness of the fourth layer. The first layer is used for close contact of the first vibration plate 131 and the second electrode 53. The fourth layer is a seed layer for improving the orientation of the first piezoelectric body 51. Since the fourth layer is provided, island-shaped titanium serves as a crystal core when the first piezoelectric body 51 is formed, which improves the orientation of the first piezoelectric body 51. The above-described fourth electrodes 33 may have the same configuration as the second electrode 53.

Although only the second electrode 53 is illustrated in FIG. 5, the plane area of each of the first electrode 52 and the first piezoelectric body 51 is substantially equal to the plane area of the second electrode 53, and the first electrode 52 and the first piezoelectric body 51 overlap the second electrode 53 in a plan view. The first piezoelectric body 51, the first electrode 52, and the second electrode 53 overlap a substantially entire range of the pressure detection chamber S2 in a plan view.

The capacitance of the first piezoelectric body 51 changes in accordance with pressure in the pressure detection chamber S2. The capacitance of the first piezoelectric body 51 is correlated with pressure P, and thus pressure in the pressure detection chamber S2 can be sensed based on the capacitance of the first piezoelectric body 51. Specifically, as pressure in the pressure detection chamber S2 changes, the first vibration plate 131 deforms in accordance with the pressure change. The first vibration plate 131 deflects and deforms in the Z1 direction or the Z2 direction. As the first vibration plate 131 deforms, stress is applied on the first piezoelectric body 51 on the first vibration plate 131 and distortion occurs to the first piezoelectric body 51. With the stress application to the first piezoelectric body 51, the polarization state of the first piezoelectric body 51 changes. The polarization state change appears as change in the permittivity & of the first piezoelectric body 51, and accordingly, change occurs to capacitance. In this manner, capacitance changes in accordance with change of pressure in the pressure detection chamber S2.

The capacitance is expressed by Expression [1].

$$C = ε ( S / d ) \qquad [ 1 ]$$

In the expression, C is the capacitance, S is electrode area, and d is the distance between the first electrode 52 and the second electrode 53.

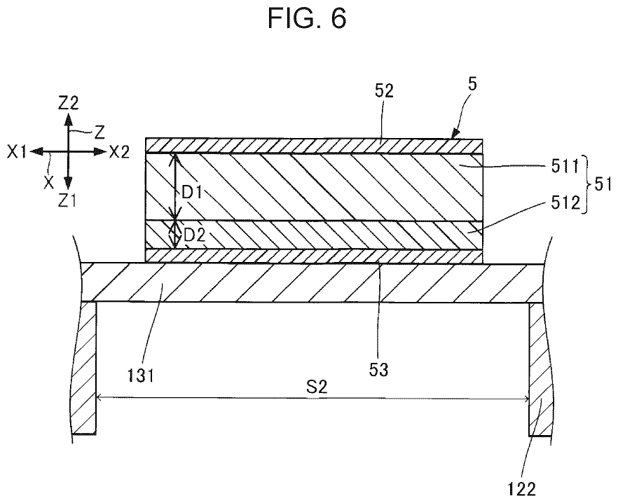

FIG. 6 is a cross-sectional view of the pressure detection element 5 in FIG. 3. As illustrated in FIG. 6, the first piezoelectric body 51 is disposed between the first electrode 52 and the second electrode 53. The capacitance of the first piezoelectric body 51 changes in accordance with pressure in the pressure detection chamber S2. The first electrode 52 is positioned on a side opposite the pressure detection chamber S2 with respect to the first piezoelectric body 51. The second electrode 53 is positioned on the pressure detection chamber S2 side of the first piezoelectric body 51.

The first piezoelectric body 51 includes a first piezoelectric layer 511 and a second piezoelectric layer 512. The first piezoelectric layer 511 is positioned on the first electrode 52 side and contacts the first electrode 52. The second piezoelectric layer 512 is positioned on the second electrode 53 side and contacts the second electrode 53. The second piezoelectric layer 512 and the first piezoelectric layer 511 contact each other. In the present embodiment, the plane area of the first piezoelectric layer 511 is substantially equal to the plane area of the second piezoelectric layer 512. Similarly, the cross-sectional area of the first piezoelectric body 51 when viewed in the thickness direction is substantially equal to the cross-sectional area of each second piezoelectric body 31 when viewed in the thickness direction.

The first piezoelectric layer 511 and the second piezoelectric layer 512 are in different crystal systems. Specifically, the second piezoelectric layer 512 is in the tetragonal, cubic, or monoclinic crystal system. The first piezoelectric layer 511 is in the rhombohedral crystal system. In the tetragonal crystal system, the three crystal axes a, b, and c are orthogonal to one another, and two of the axes have equal lengths whereas one of the axes has a different length. In the cubic crystal system, the three crystal axes a, b, and c are orthogonal to one another and have equal lengths. In the monoclinic crystal system, the three crystal axes a, b, and c are orthogonal to one another and have lengths different from one another. In the rhombohedral crystal system, the three crystal axes a, b, and c have equal lengths, but two of three angles α, β, and γ of the axes are 90° whereas the remaining one angle is 120°.

The degree of deformation is larger in the rhombohedral crystal system than in the tetragonal, cubic, and monoclinic crystal systems. For example, among the three crystal axes of the tetragonal crystal, the lengths of two axes are equal to each other, and the length of the remaining one axis is different from the lengths of the other two axes. The three crystal axes of the monoclinic crystal are different from one another. The lengths of the three crystal axes of the rhombohedral crystal are equal to one another. Accordingly, crystal deformation is larger in the rhombohedral crystal than in the tetragonal crystal and the monoclinic crystal.

Thus, the degree of distortion with stress is different between the first piezoelectric layer 511 and the second piezoelectric layer 512. When the same stress is applied, distortion of the second piezoelectric layer 512 is larger than distortion of the first piezoelectric layer 511. Accordingly, a phenomenon called flexoelectricity that the occurrence of electric imbalance causes permittivity change occurs to the first piezoelectric body 51. With flexoelectricity, difference in the degree of distortion occurs between the first electrode 52 side and the second electrode 53 side of the first piezoelectric body 51, and large permittivity change occurs. Accordingly, large capacitance change occurs. Since capacitance and pressure are correlated with each other, it is possible to detect pressure in the pressure detection chamber S2 at high sensitivity by using the first piezoelectric body 51.

Deformation of a piezoelectric body is small even with large stress application. If the first piezoelectric body 51 is constituted by only one of the first piezoelectric layer 511 and the second piezoelectric layer 512, distortion difference is unlikely to occur between the first electrode 52 side and the second electrode 53 side of the first piezoelectric body 51 with large pressure application. Accordingly, permittivity change is small, and thus high accuracy of pressure detection is unlikely to be achieved. However, in the present embodiment, the first piezoelectric body 51 is formed of two layers of the first piezoelectric layer 511 and the second piezoelectric layer 512 between which the degree of distortion is different as described above. Thus, pressure can be detected at high sensitivity.

Moreover, a thickness D2 of the second piezoelectric layer 512 is smaller than a thickness D1 of the first piezoelectric layer 511. As the thickness D2 of the second piezoelectric layer 512 is smaller, the amount of distortion of the second piezoelectric layer 512 is larger and accordingly, the permittivity is larger. Accordingly, the thickness and the permittivity are inversely proportional to each other. Thus, distortion amount difference between the first piezoelectric layer 511 and the second piezoelectric layer 512 can be increased when the thickness D2 of the second piezoelectric layer 512, the degree of distortion of which is larger than the first piezoelectric layer 511, is set to be smaller than the thickness D1 of the first piezoelectric layer 511. As a result, large permittivity change occurs between the first electrode 52 side and the second electrode 53 side of the first piezoelectric body 51. Thus, pressure in the pressure detection chamber S2 can be detected at high sensitivity.

The thickness D2 of the second piezoelectric layer 512 may be larger than 1/14 of the thickness D1 of the first piezoelectric layer 511. When the thickness D2 of the second piezoelectric layer 512 is larger than the above-described numerical value, the second piezoelectric layer 512 can be more easily formed than when the thickness is smaller. At this viewpoint, the thickness D2 may be larger than 1/13 of the thickness D1 thick or may be larger than 1/12 of the thickness D1.

The thickness D2 of the second piezoelectric layer 512 may be smaller than ⅛ of the thickness D1 of the first piezoelectric layer 511. When the thickness D2 of the second piezoelectric layer 512 is smaller than the above-described numerical value, pressure in the pressure detection chamber S2 can be detected at particularly higher sensitivity than when the thickness is larger. At a viewpoint of higher pressure detection sensitivity, the thickness D2 may be smaller than 1/9 of the thickness D1 or may be smaller than 1/10 of the thickness D2.

The Young's modulus of the second piezoelectric layer 512 is smaller than the Young's modulus of the first piezoelectric layer 511. Accordingly, the degree of distortion with stress is different between the first piezoelectric layer 511 and the second piezoelectric layer 512. When the same stress is applied to the first piezoelectric layer 511 and the second piezoelectric layer 512, the degree of distortion of the second piezoelectric layer 512 is larger than that of the first piezoelectric layer 511. As a result, as described above, a phenomenon called flexoelectricity that the occurrence of electric imbalance causes permittivity change occurs inside the first piezoelectric body 51. With flexoelectricity, difference in the degree of distortion occurs between the first electrode 52 side and the second electrode 53 side of the first piezoelectric body 51, and large permittivity change occurs. Accordingly, large capacitance change occurs. Thus, since capacitance and pressure are correlated with each other, it is possible to detect pressure in the pressure detection chamber S2 at high sensitivity by using the first piezoelectric body 51.

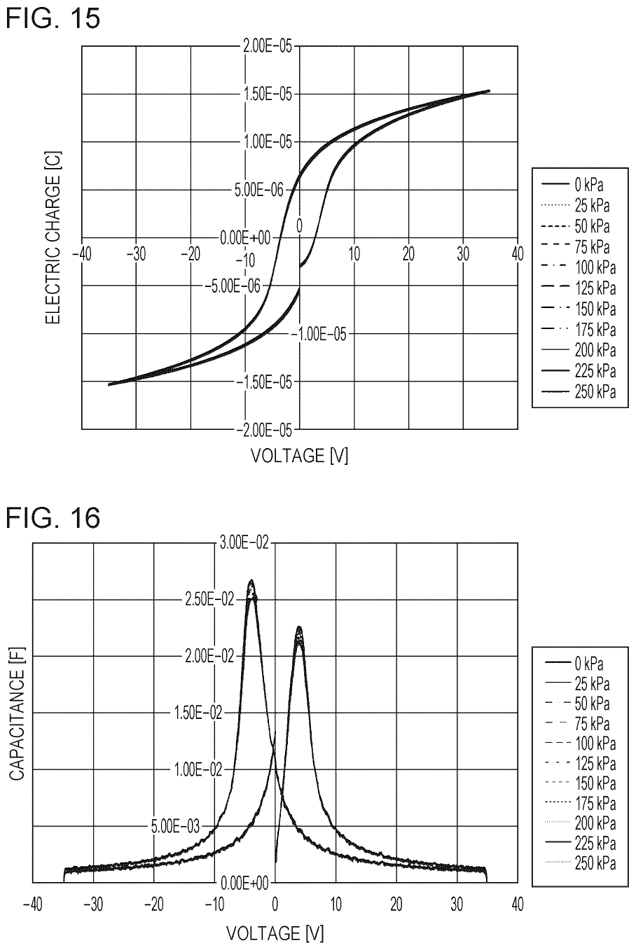

FIG. 15 is a diagram illustrating an example of the relation between voltage and electric charge. FIG. 16 is a diagram illustrating an example of the relation between voltage and capacitance. The examples illustrated in FIGS. 15 and 16 are results of measurement of electric charge or capacitance of the first piezoelectric body 51 per unit electrode area when, for example, voltage of a triangular waveform is applied between the first electrode 52 and the second electrode 53. The measurement is performed while pressure is applied.

The first piezoelectric body 51 has a hysteresis characteristic as illustrated in FIG. 15. The magnitude of electric field at voltage with which electric charge is zero in FIG. 15 is a coercive electric field. In the present example, voltage corresponding to the coercive electric field is ±4 V approximately. As understood from FIG. 16, large capacitance change occurs in the vicinity of ±4 V in the present example. Thus, in the present example, the change rate of capacitance against pressure can be maximized by applying, for example, sine waves centered at ±4 V to the first electrode 52 of the pressure detection element 5.

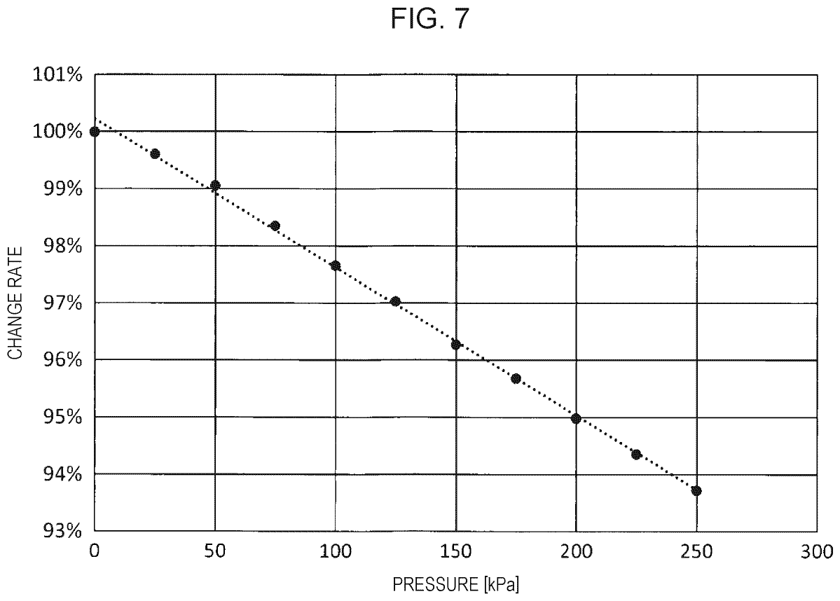

FIG. 7 is a graph illustrating an example of the relation between capacitance C of the first piezoelectric body 51 and the pressure P. In FIG. 7, the horizontal axis represents the pressure P [kPa], and the vertical axis represents the change rate of the capacitance. The change rate plots a peak value of the capacitance at each pressure with respect to a reference that is a peak value of the capacitance at pressure 0 [kPa] in FIG. 16. In the example illustrated in FIG. 7, the change rate of the capacitance of the first piezoelectric body 51 decreases as the pressure P increases. For example, it is understood that the capacitance changes by 2.5% approximately up to 100 [kPa].

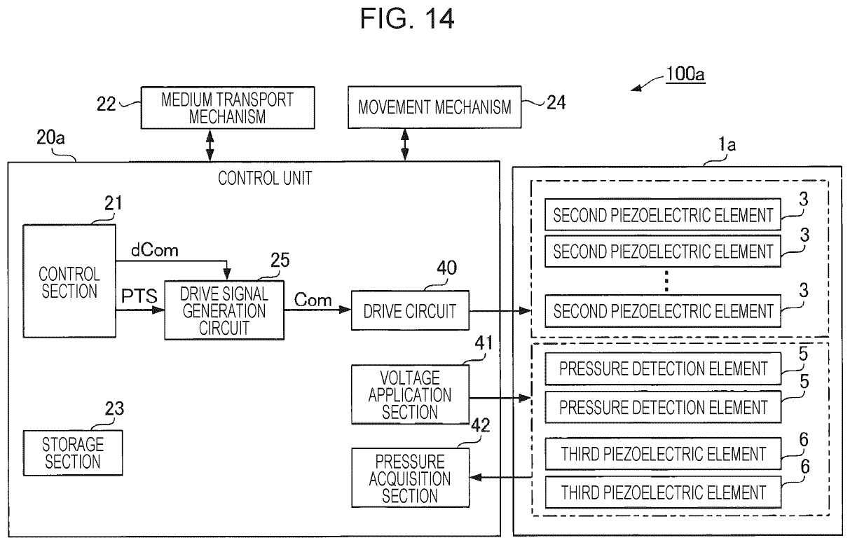

As understood from FIGS. 7 and 14, change rate of capacitance against pressure can be maximized by using voltage corresponding to the coercive electric field of the first piezoelectric body 51. Thus, pressure in the pressure detection chamber S2 may be detected based on capacitance change when the voltage corresponding to the coercive electric field of the first piezoelectric body 51 is applied. Pressure in the pressure detection chamber S2 can be detected at high sensitivity by using the voltage corresponding to the coercive electric field. For example, according to the examples illustrated in FIGS. 7 and 16, for example, sine waves in the range of ±0.1 V centered at 4 V may be applied to the first electrode 52 of the pressure detection element 5. Voltage other than the voltage corresponding to the coercive electric field may be used.

As described above, the pressure detection element 5 is provided corresponding to the pressure detection chamber S2. The pressure chambers S1 and the pressure detection chamber S2 are provided in the pressure chamber substrate 12, and the pressure chambers S1 and the pressure detection chamber S2 are adjacent to each other. In the form that the pressure chambers S1 and the pressure detection chamber S2 are adjacent to each other, the pressure detection element 5 is provided corresponding to the pressure detection chamber S2. With this configuration, pressure in the pressure detection chamber S2 adjacent to the pressure chambers S1 can be acquired by the pressure detection element 5, and thus ink behavior or the like in accordance with pressure in the pressure chambers S1 can be sensed. Accordingly, it is possible to sense the occurrence of various kinds of failure such as insufficiency of ink supply to the plurality of pressure chambers S1 and the pressure detection chamber S2. In this manner, pressure in the pressure detection chamber S2 in the vicinity of the pressure chambers S1 can be acquired, which can contribute to quality improvement of the liquid discharge head 1.

The pressure detection chamber S2 is not directly related to ink discharge like the pressure chambers S1. Thus, detection of pressure in the pressure detection chamber S2 based on voltage applied to the first piezoelectric body 51 is always possible irrespective of ink discharge.

As described above, the pressure detection chamber S2 has a function to absorb ink vibration that occurs when pressure is applied to ink in the pressure chambers S1. Accordingly, ink discharge performance can be stabilized when the pressure detection chamber S2 is provided. In the present embodiment, the pressure detection element 5 is provided corresponding to the pressure detection chamber S2. Thus, pressure in the vicinity of the pressure chambers S1 can be detected by using the pressure detection chamber S2. In other words, it is possible to detect pressure in the vicinity of the pressure chambers S1 with a simple configuration without redundantly forming a space or the like for detecting pressure in the vicinity of the pressure chambers S1.

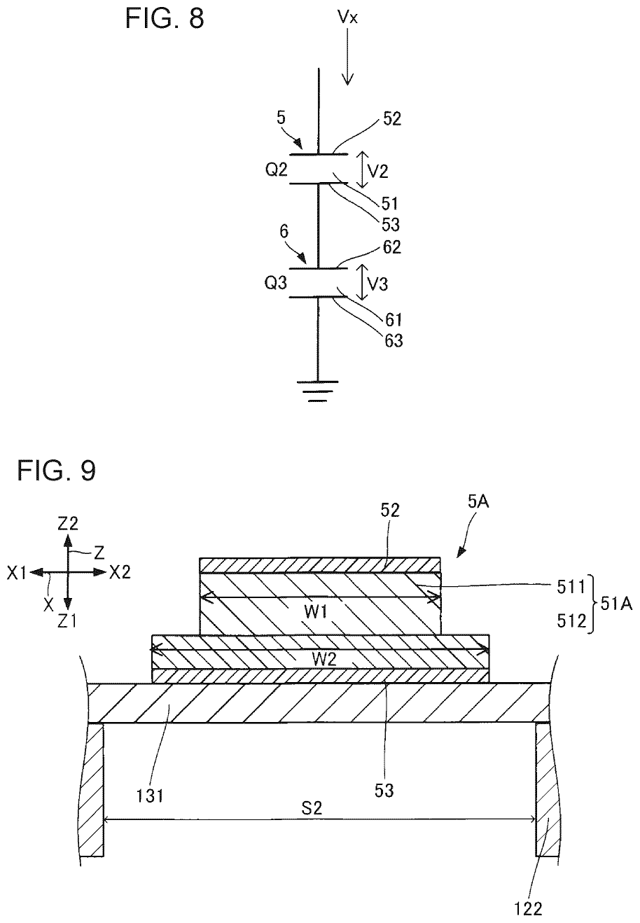

FIG. 8 is a diagram illustrating the pressure detection element 5 and the third piezoelectric element 6 in FIG. 2. The third piezoelectric element 6 illustrated in FIG. 8 is a piezoelectric element for reference. The third piezoelectric element 6 is connected in series to the pressure detection element 5. The third piezoelectric element 6 is not disposed on the vibration plate 13 described above but is provided at a place where the third piezoelectric element 6 does not deform due to pressure in a flow path.

The third piezoelectric element 6 has the same configuration as the pressure detection element 5. The third piezoelectric element 6 includes a third piezoelectric body 61, a fifth electrode 62, and a sixth electrode 63. The third piezoelectric body 61 is sandwiched between the fifth electrode 62 and the sixth electrode 63. The third piezoelectric body 61 is a dielectric body and formed of a well-known piezoelectric material such as piezoelectric zirconate titanate. The capacitance of the third piezoelectric body 61 is known.

The fifth electrode 62 and the sixth electrode 63 are each formed of a conductive material such as platinum or iridium. The fifth electrode 62 is electrically connected to the second electrode 53 of the pressure detection element 5. Constant predetermined voltage is applied to the sixth electrode 63. In the illustrated example, the predetermined voltage is ground voltage and the sixth electrode 63 is grounded. For example, the voltage corresponding to the coercive electric field described above may be applied as predetermined voltage Vx to the first electrode 52 of the pressure detection element 5 described above. Accordingly, the voltage application section 41 in FIG. 2 applies the predetermined voltage Vx to the first piezoelectric body 51 and the third piezoelectric body 61.

Capacitance C2 of the first piezoelectric body 51 can be calculated based on voltage V2 applied to the first piezoelectric body 51, voltage V3 applied to the third piezoelectric body 61, and capacitance C3 of the third piezoelectric body 61, as expressed in [4] below.

$$V 2 = C 2 \times Q 2 \qquad [ 2 ]$$

$$V 3 = C 3 \times Q 3 \qquad [ 3 ]$$

$$C 2 = ( V 2 / V 3 ) \times C 3 \qquad [ 4 ]$$

Expression [4] is derived from Expressions [2] and [3]. Q2 is electric charge generated at the pressure detection element 5, and Q3 is electric charge generated at the third piezoelectric element 6. The voltage V2 is voltage applied to the first piezoelectric body 51 when the predetermined voltage Vx is applied by the voltage application section 41. The voltage V3 is voltage applied to the third piezoelectric body 61 when the predetermined voltage Vx is applied by the voltage application section 41.

The voltage V2 applied to the first piezoelectric body 51 changes as the capacitance C of the first piezoelectric body 51 changes when stress is applied to the first piezoelectric body 51. A signal of the voltage V2 is acquired by the pressure acquisition section 42 in FIG. 2. The capacitance C2 of the first piezoelectric body 51 is calculated by Expression [4] by using the voltage V2, the voltage V3, and the capacitance C3, which is known. Thus, the pressure acquisition section 42 acquires the capacitance C2 based on the voltage V2, the voltage V3, and the capacitance C3. Then, the pressure P of the first piezoelectric body 51 is calculated from the capacitance C2 and the capacitance-pressure correlation illustrated in FIG. 7. In this manner, the pressure acquisition section 42 acquires pressure in the pressure detection chamber S2 based on capacitance.

In the present embodiment, as described above, the pressure acquisition section 42 obtains the capacitance C2 of the first piezoelectric body 51 by using the third piezoelectric body 61 with the known capacitance C3 and detects pressure in the pressure detection chamber S2 based on the capacitance C2. According to the detection method using the third piezoelectric body 61, it is possible to sense pressure in the pressure detection chamber S2 in the vicinity of the pressure chambers S1 with a simple configuration. The method of detecting pressure in the pressure detection chamber S2 is not limited to the detection method using the third piezoelectric body 61, and the third piezoelectric element 6 may be omitted depending on a detection method.

As described above, at least the plurality of pressure chambers S1 and the one pressure detection chamber S2 connected in common to the plurality of pressure chambers S1 are provided in the pressure chamber substrate 12. Since the volume of the pressure detection chamber S2 is larger than the volume of each pressure chamber S1, the plane area of the first vibration plate 131 that forms the pressure detection chamber S2 can be set to be larger than the plane area of each second vibration plate 132 that forms the corresponding pressure chamber S1. Accordingly, displacement of the first vibration plate 131 can be set to be larger than displacement of the second vibration plates 132.

Since pressure in the one pressure detection chamber S2 connected in common to the plurality of pressure chambers S1 can be sensed, pressure in the pressure detection chamber S2 due to influence of the plurality of pressure chambers S1 can be sensed instead of pressure in each pressure chamber S1. Thus, the pressure can be used for failure sensing of, for example, the occurrence of various kinds of failure such as ink supply insufficiency.

Since the one pressure detection chamber S2 connected in common to the plurality of pressure chambers S1 is provided, the plane area of the first piezoelectric body 51 is larger than the plane area of each second piezoelectric body 31. Similarly, the cross-sectional area of the first piezoelectric body 51 when viewed in the thickness direction is larger than the cross-sectional area of each second piezoelectric body 31 when viewed in the thickness direction. The capacitance of the first piezoelectric body 51 can be increased as the cross-sectional area of the first piezoelectric body 51 increases. Accordingly, the accuracy of pressure detection can be increased. However, too large cross-sectional area of each second piezoelectric body 31 leads to too large excluded volume and potentially results in an excessive discharge amount.

A direction in which deflection is easier is different between the second piezoelectric body 31 and the first piezoelectric body 51. The pressure chambers S1, the second piezoelectric bodies 31, and the fourth electrodes 33 have elongated shapes in the X2 direction. The second piezoelectric bodies 31 and the fourth electrodes 33 are likely to extend in the X2 direction when the excluded volume is maximized since the pressure chambers S1 extend in the X2 direction. Accordingly, the second piezoelectric bodies 31 and the fourth electrodes 33 are likely to deflect about the vicinity of the center in the X2 direction. Thus, discharge accuracy can be increased by providing the second piezoelectric bodies 31 in the extending direction of the pressure chambers S1.

The pressure detection chamber S2, the first piezoelectric body 51, and the second electrode 53 have elongated shapes in the Y2 direction. Accordingly, the first piezoelectric body 51 and the second electrode 53 are likely to deflect about the vicinity of the center in the Y2 direction. Moreover, the pressure detection chamber S2 is provided in common to the plurality of pressure chambers S1, and pressure is applied to the pressure detection chamber S2 from the plurality of pressure chambers S1 in common. Pressure is unlikely to be concentratively applied only from a particular pressure chamber S1. At this viewpoint as well, the first piezoelectric body 51 and the second electrode 53 are likely to deflect about the vicinity of the center in the Y2 direction. Thus, pressure detection sensitivity can be increased by providing the first piezoelectric body 51 in the extending direction of the pressure detection chamber S2.

For example, the first piezoelectric body 51 and the second electrode 53 may be disposed in the X2 direction. However, in this case, the deflection amounts of the first piezoelectric body 51 and the second electrode 53 are smaller than those when the first piezoelectric body 51 and the second electrode 53 are disposed in the X2 direction.

As illustrated in FIG. 5, the second electrode 53 overlaps the center of the pressure detection chamber S2 in the X2 direction. Similarly, the first electrode 52 and the first piezoelectric body 51 overlap the center of the pressure detection chamber S2 in the X2 direction. Accordingly, the pressure detection element 5 overlaps the center of the first vibration plate 131 in the X2 direction. The center of the first vibration plate 131 in the X2 direction is a part that is displaced most. Thus, the detection accuracy of pressure in the pressure detection chamber S2 can be increased when the pressure detection element 5 overlaps the center of the pressure detection chamber S2 in the X2 direction. The pressure detection element 5 does not necessarily need to overlap the center in the X2 direction.

### 2. Modifications

The embodiment exemplarily described above may be modified in various manners. Specific modified aspects applicable to the above-described embodiment will be exemplarily described below. Two or more aspects optionally selected from among those exemplarily described below may be merged as appropriate without inconsistency.

FIG. 9 is a cross-sectional view of a pressure detection element 5A according to a modification. In the pressure detection element 5A, the plane area of the first piezoelectric layer 511 and the plane area of the second piezoelectric layer 512 are different from each other. The plane area of the second piezoelectric layer 512 is larger than the plane area of the first piezoelectric layer 511. Similarly, the cross-sectional area of the first piezoelectric layer 511 when viewed in the thickness direction and the cross-sectional area of the second piezoelectric layer 512 when viewed in the thickness direction are different from each other. The cross-sectional area of the second piezoelectric layer 512 when viewed in the thickness direction is larger than the cross-sectional area of the first piezoelectric layer 511 when viewed in the thickness direction. Accordingly, in the illustrated example, a width W2 that is the length of the second piezoelectric layer 512 in the X2 direction is larger than a width W1 that is the length of the first piezoelectric layer 511 in the X2 direction.

Permittivity change can be increased when the cross-sectional area of the second piezoelectric layer 512 when viewed in the thickness direction is larger than the cross-sectional area of the first piezoelectric layer 511 when viewed in the thickness direction. The cross-sectional area of the first piezoelectric layer 511 may be larger than the cross-sectional area of the second piezoelectric layer 512.

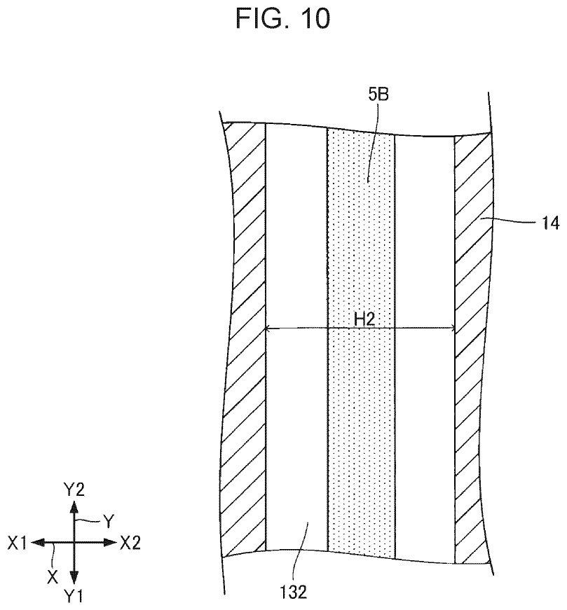

FIG. 10 is a plan view illustrating a pressure detection element 5B according to a modification. The pressure detection element 5B illustrated in FIG. 10 does not overlap the entire range of the pressure detection chamber S2 in a plan view but overlaps the center of the pressure detection chamber S2 in the X2 direction. For example, the length of the first piezoelectric body 51 in the X2 direction is equal to or smaller than half of the lengths of the pressure detection chamber S2 and the first vibration plate 131 in the X2 direction.

Since the first piezoelectric body 51 is not provided in the entire range of the pressure detection chamber S2 in a plan view, the first vibration plate 131 more easily deforms than when the first piezoelectric body 51 is provided in the entire range. The detection accuracy of pressure in the pressure detection chamber S2 can be increased by providing the first piezoelectric body 51 over the center of the first vibration plate 131 in the X2 direction, which is most easily displaced.

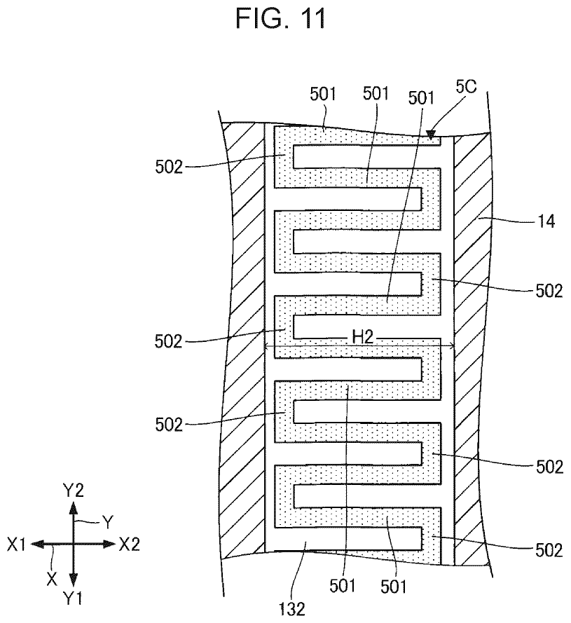

FIG. 11 is a plan view illustrating a pressure detection element 5C according to a modification. The pressure detection element 5C illustrated in FIG. 11 has an accordion shape that extends in the X2 direction and sequentially folds in the Y2 direction.

The pressure detection element 5C includes a plurality of first parts 501 and a plurality of second parts 502. The plurality of first parts 501 are parts extending in the X2 direction, separated from each other, and arranged in the Y2 direction. The plurality of second parts 502 are parts extending in the Y2 direction. Each second part 502 is disposed between two adjacent first parts 501 and connects the two adjacent first parts 501. The plurality of second parts 502 are alternately arranged at the ends of the first parts 501 in the X1 direction and the ends of the first parts 501 in the X2 direction. The plurality of second parts 502 are counted in the Y2 direction with the first at the second part 502 positioned farthest in the Y1 direction among the plurality of second parts 502. In this case, for example, the odd-numbered second parts 502 among the plurality of second parts 502 are connected to the ends of the first parts 501 in the X2 direction. The even-numbered second parts 502 among the plurality of second parts 502 are connected to the ends of the first parts 501 in the X1 direction.

The first piezoelectric body 51, the first electrode 52, and the second electrode 53 included in the pressure detection element 5C are disposed in an accordion shape that extends in the X2 direction and sequentially folds. Since the pressure detection element 5C has an accordion shape, the pressure detection element 5C is more likely to receive stress due to deformation of the first vibration plate 131 than in the case of an elongated shape in the Y2 direction like the pressure detection element 5 according to the first embodiment. Moreover, since the pressure detection element 5C has an accordion shape, plane area is smaller than in the pressure detection element 5 according to the first embodiment. Thus, the volume of the pressure detection element 5C on the first vibration plate 131 decreases. Accordingly, the first vibration plate 131 is likely to deform. As a result, the detection accuracy of pressure in the pressure detection chamber S2 can be increased.

The shape of the pressure detection element 5C may be a shape that is likely to receive stress due to deformation of the first vibration plate 131, and is not limited to the illustrated accordion shape.

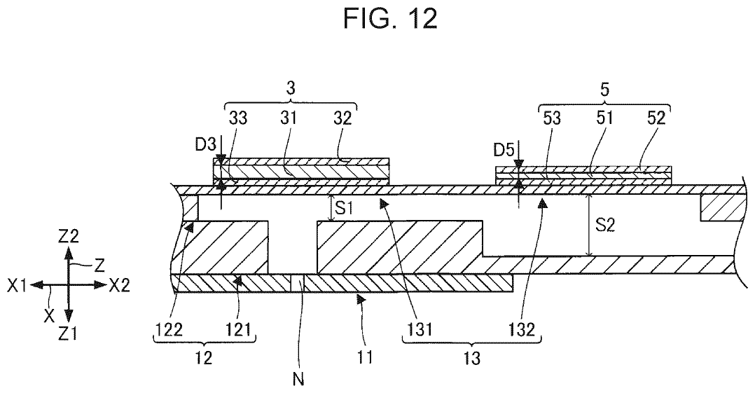

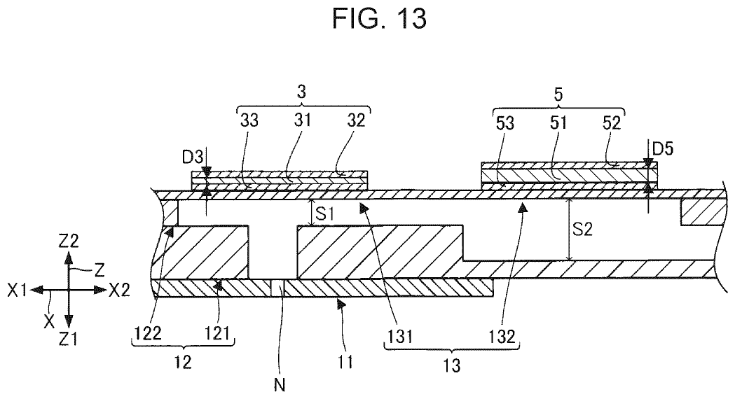

FIGS. 12 and 13 are each a cross-sectional view of a second piezoelectric element 3 and a pressure detection element 5 according to a modification. A thickness D5 of the first piezoelectric body 51 of the pressure detection element 5 may be different from a thickness D3 of the second piezoelectric body 31 of the second piezoelectric element 3.

For example, in FIG. 12, the thickness D5 of the first piezoelectric body 51 is smaller than the thickness D3 of the second piezoelectric body 31. With the smaller thickness, the first piezoelectric body 51 more easily deforms than the second piezoelectric body 31. Since the thickness D5 is smaller than the thickness D3, the detection accuracy of pressure in the pressure detection chamber S2 can be increased as compared to a case where the thickness D5 is larger than the thickness D3. However, the second piezoelectric body 31 is a part that contributes to discharge. Thus, crack and the like can be reduced when the thickness D5 is larger than the thickness D3.

For example, in FIG. 13, the thickness D5 of the first piezoelectric body 51 is larger than the thickness D3 of the second piezoelectric body 31. Since the thickness D5 is larger than the thickness D3, in other words, since the thickness D3 is smaller than the thickness D5, the second piezoelectric body 31 more easily deforms than the first piezoelectric body 51. Thus, ink discharge performance can be increased.

FIG. 14 is a block diagram of a liquid discharge device 100a according to a modification. The liquid discharge device 100a includes a liquid discharge head 1a and a control unit 20a. The drive circuit 40, the voltage application section 41, and the pressure acquisition section 42 are provided at the control unit 20a. The voltage application section 41 and the pressure acquisition section 42 are not provided at the liquid discharge head 1a.

As illustrated in FIG. 14, the drive circuit 40, the voltage application section 41, and the pressure acquisition section 42 may be each partially or entirely provided at the control unit 20. With the liquid discharge device 100a as well, pressure in the vicinity of the pressure chambers S1 can be acquired by using the pressure detection chamber S2 as a space that absorbs ink vibration as in each embodiment.

A “liquid discharge head” may be what is called a circulation-type head including a circulation flow path. Moreover, in the embodiment, the third electrode 32 is a common electrode and the fourth electrodes 33 are individual electrodes, but the third electrode 32 may be an individual electrode and the fourth electrodes 33 may be a common electrode.

A “pressure detection element” is not limited to an element used for the “liquid discharge head” but may be used for any other device. The other device is, for example, a pressure-electricity converter or a piezoelectric transformer. The “pressure detection element” is applicable as a sensor such as a pressure sensor.

The “liquid discharge device” may be employed for an instrument dedicated to printing as well as various instruments such as a facsimile device and a photocopier. Usage of the liquid discharge device is not limited to printing. For example, a liquid discharge device that discharges color material solution is used as a manufacturing device that forms a color filter of a display device such as a liquid crystal display panel. A liquid discharge device that discharges conductive material solution is used as a manufacturing device that forms wires and electrodes of a wiring substrate. A liquid discharge device that discharges organic substance solution related to a living body is used as, for example, a manufacturing device that manufactures biochips.

The present disclosure is described above based on the preferable embodiments, but the present disclosure is not limited to the above-described embodiments. Moreover, the configuration of each component of the present disclosure may be replaced with or additionally include an optional configuration having the same function in the above-described embodiment.

What is claimed is:

1. A pressure detection element comprising:
a pressure detection chamber for detecting pressure inside;
a first electrode;
a second electrode; and
a first piezoelectric body that is disposed between the first and second electrodes and capacitance of which changes in accordance with the pressure of the pressure detection chamber, wherein
the first piezoelectric body includes a first piezoelectric layer positioned on the first electrode side and a second piezoelectric layer positioned on the second electrode side,
the second piezoelectric layer is in the tetragonal, cubic, or monoclinic crystal system,
the first piezoelectric layer is in the rhombohedral crystal system, and
thickness of the second piezoelectric layer is smaller than thickness of the first piezoelectric layer.

2. The pressure detection element according to claim 1, wherein Young's modulus of the second piezoelectric layer is smaller than Young's modulus of the first piezoelectric layer.

3. The pressure detection element according to claim 1, wherein thickness of the second piezoelectric layer is larger than 1/14 of thickness of the first piezoelectric layer.

4. The pressure detection element according to claim 1, wherein the thickness of the second piezoelectric layer is smaller than ⅛ of the thickness of the first piezoelectric layer.

5. The pressure detection element according to claim 1, wherein cross-sectional area of the second piezoelectric layer when viewed in a thickness direction is larger than cross-sectional area of the first piezoelectric layer when viewed in the thickness direction.

6. The pressure detection element according to claim 1, wherein
the first electrode is positioned on a side opposite the first piezoelectric body with respect to the pressure detection chamber, and
the second electrode is positioned on the pressure detection chamber side of the first piezoelectric body.

7. The pressure detection element according to claim 1, wherein the pressure of the pressure detection chamber is detected based on change in capacitance when voltage corresponding to coercive electric field of the first piezoelectric body is applied.

8. A pressure detection element comprising:
a pressure detection chamber for detecting pressure inside;
a first electrode;
a second electrode; and
a first piezoelectric body that is disposed between the first and second electrodes and capacitance of which changes in accordance with the pressure of the pressure detection chamber, wherein
the first piezoelectric body includes a first piezoelectric layer positioned on the first electrode side and a second piezoelectric layer positioned on the second electrode side,
Young's modulus of the second piezoelectric layer is smaller than Young's modulus of the first piezoelectric layer, and
thickness of the second piezoelectric layer is smaller than thickness of the first piezoelectric layer.

9. A liquid discharge head comprising:
the pressure detection element according to claim 1;
a nozzle substrate provided with a nozzle that discharges liquid; and
a pressure chamber substrate including a pressure chamber in which pressure for discharging liquid from the nozzle is applied to liquid and the pressure detection chamber adjacent to the pressure chamber; and
a second piezoelectric body that is provided corresponding to the pressure chamber and applies pressure to the pressure chamber upon voltage application,
wherein the pressure detection element is provided corresponding to the pressure detection chamber.

10. The liquid discharge head according to claim 9, wherein the pressure detection chamber has a function to absorb liquid vibration that occurs when pressure is applied to liquid in the pressure chamber.

11. The liquid discharge head according to claim 9, wherein thickness of the first piezoelectric body is smaller than thickness of the second piezoelectric body.

12. The liquid discharge head according to claim 9, wherein cross-sectional area of the first piezoelectric body when viewed in a thickness direction is larger than cross-sectional area of the second piezoelectric body when viewed in the thickness direction.

13. A liquid discharge device comprising:
the liquid discharge head according to claim 9; and
a control section configured to control discharge operation from the liquid discharge head.
